(19) United States
(12) Patent Application Publication
(10) Pub. No.: US 2010/0304914 A1
(43) Pub. Date: Dec. 2, 2010

(54) LIMITED SLIP DIFFERENTIAL WITH POSITIVE LUBE FLOW TO CLUTCH PLATES

(76) Inventors: Mark S. Barrett, Orion, MI (US); Gregory J. Hilker, Canton, MI (US); William G. Hunt, Tecumseh, MI (US); Gregory E. Woodside, Troy, MI (US)

Correspondence Address: HARNESS, DICKEY & PIERCE, P.L.C., P.O. BOX 828, BLOOMFIELD HILLS, MI, 48303, US

(21) Appl. No.: 12/473,731

(22) Filed: May 28, 2009

(51) Int. Cl. F16H 57/04; F16H 48/22

(52) U.S. Cl. 475/160

(57) ABSTRACT

A differential with a differential case, a differential gear set and a clutch pack. Apertures are formed axially through the differential case and the clutch pack to facilitate the introduction of lubricant through the differential case and into the clutch pack. An axle assembly and a method of operating an axle assembly are also provided.

### INTRODUCTION

The present invention generally relates to a differential with improved lubrication flow to a set of clutch plates.

Cutch-type limited slip differentials typically have two clutch packs each of which being mounted between the differential case and an associated side gear. Each clutch pack can include a set of first clutch plates, which can be non-rotatably coupled to the differential case, and a set of second clutch plates that can be non-rotatably coupled to an associated side gear and interleaved with the first clutch plates. The first and second clutch plates can be engaged to and released from one another depending on the amount of torque that is transmitted through the differential. With increasing torque transmission, meshing engagement of the side gears with the pinion gears of the differential can urge the side gears axially apart from one another so as to compress the clutch packs so that the first and second clutch plates frictionally engage one another. It will be appreciated that frictional engagement of the first and second clutch plates will couple the side gears to the differential case to prevent speed differentiation between the side gears when the counter-torque acting on the side gears is smaller than the clutch torque produced by the clutch packs.

Lubrication for the clutch packs in a clutch-type limited slip differential can be introduced through large openings in the sides of the differential case. In such situations, it is desired that the lubrication entering the differential case migrate around and behind the side gears and travel to and between the first and second clutch plates. We have noted, however, that the path for this lubrication is frequently complex and that in some situations, the complexity of this path may limit the amount of lubrication that can be transmitted to the first and second clutch plates.

Another drawback with the known lubrication systems for the clutch packs in a clutch-type limited slip differential concerns the effectiveness with which the first and second clutch plates can be lubricated. In this regard, the first and second clutch plates tend to be best lubricated when the differential is operated at different rotational speeds so that the first and second clutch plates are alternately squeezed together and then allowed to disengage or separate. In situations where the differential is operated at a moderate (or higher) rotational speed that is relatively consistent (e.g., as when a vehicle is operated on a relatively flat and straight highway with the cruise control set to cause the vehicle to travel at a desired highway speed), the amount of lubrication that is received by the clutch plates can be less than desired, which can lead to undesired noise or shudder when the differential is operated in a cornering event (i.e., when a vehicle equipped with the differential travels around a corner).

In view of the above remarks, there remains a need in the art for an improved differential. There also remains a need in the art for an improved method for providing lubrication to the clutch plates in a clutch-type limited slip differential.

### SUMMARY

This section provides a general summary of some aspects of the present disclosure and is not a comprehensive listing or detailing of either the full scope of the disclosure or all of the features described therein.

In one form, the present teachings provide a differential with a differential case, a differential gear set and a clutch pack. The differential case has a first end, a second end opposite the first end and an internal cavity between the first and second ends. A plurality of first lubrication apertures are formed through the first end and extend into the internal cavity. The differential gear set is mounted to the differential case in the internal cavity and includes a first side gear disposed proximate the first end of the differential case. The first clutch pack is disposed between the first end and the first side gear. The clutch pack includes a plurality of first clutch plates and a plurality of second clutch plates. The first clutch plates are non-rotatably coupled to the differential case, while the second clutch plates are non-rotatably coupled to the first side gear. Each of the plurality of first and second clutch plates include a plurality of second lubrication apertures extend axially therethrough.

In another form, the present teachings provide a method for operating an axle assembly having an axle housing, a differential and a pair of differential bearings that support the differential on the axle housing for rotation about an axis. The differential has a differential case, a pair of friction clutches and a differential gear set with a pair of side gears. The method includes: rotating the differential about the first axis; directing a lubricant onto the differential bearings, the lubricant being passed through the differential bearing toward the differential due to centrifugal force; and passing the lubricant passed through the differential bearing axially through the differential case and axially through at least a portion of the friction clutches.

Further areas of applicability will become apparent from the description provided herein. It should be understood that the description and specific examples in this summary are intended for purposes of illustration only and are not intended to limit the scope of the present disclosure, its application and/or uses in any way.

### BRIEF DESCRIPTION OF THE DRAWINGS

The drawings described herein are for illustrative purposes only and are not intended to limit the scope of the present disclosure in any way. The drawings are illustrative of selected teachings of the present disclosure and do not illustrate all possible implementations. Similar or identical elements are given consistent identifying numerals throughout the various figures.

FIG. 1 is a schematic illustration of a vehicle having an axle assembly constructed in accordance with the teachings of the present disclosure;

FIG. 2 is a partially broken-away perspective view of a portion of the vehicle of FIG. 1 illustrating the axle assembly in more detail;

FIG. 3 is a longitudinal sectional view of a portion of the axle assembly;

FIG. 4 is a section view taken along the line 4-4 of FIG. 3;

FIG. 5 is a section view taken through a portion of the axle assembly of FIG. 1 in a direction that is parallel to the section view of FIG. 4 but offset therefrom along the first axis so as to illustrate one of the first clutch plates;

FIG. 6 is a perspective view of one of the first clutch plates; and

FIG. 7 is a section view similar to that of FIG. 5 but offset therefrom so as to illustrate one of the second clutch plates.

### DETAILED DESCRIPTION OF THE VARIOUS EMBODIMENTS

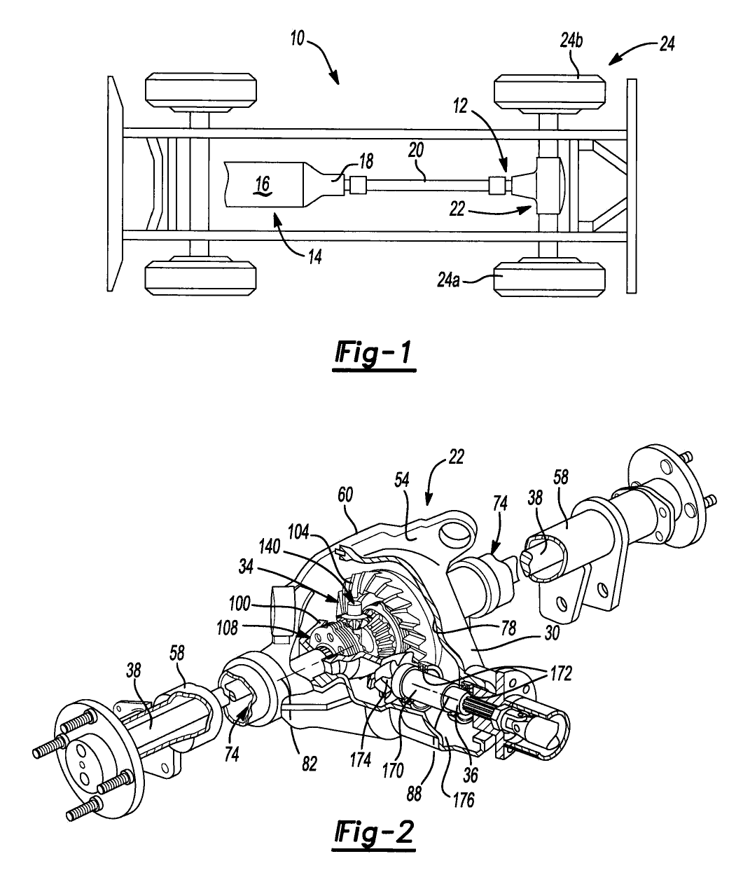

With reference to FIG. 1 of the drawings, a vehicle having a differential assembly that is constructed in accordance with the teachings of the present disclosure is generally indicated by reference numeral 10. The vehicle 10 can include a driveline 12 that is drivable via a connection to a power train 14. The power train 14 can include an engine 16 and a transmission 18. The driveline 12 can include a propshaft 20, a rear axle assembly 22 and a plurality of wheels 24. The engine 16 can be mounted in an in-line or longitudinal orientation along the axis of the vehicle 10 and its output can be selectively coupled via a conventional clutch to the input of the transmission 18 to transmit rotary power (i.e., drive torque) therebetween. The input of the transmission 18 can be commonly aligned with the output of the engine 16 for rotation about a common rotary axis. The transmission 18 can also include an output and a gear reduction unit. The gear reduction unit can be operable for coupling the transmission input to the transmission output at a predetermined gear speed ratio. The propshaft 20 can be coupled for rotation with the output of the transmission 18. Drive torque can be transmitted through the propshaft 20 to the rear axle assembly 22 where it can be selectively apportioned in a predetermined manner to the left and right rear wheels 24a and 24b, respectively.

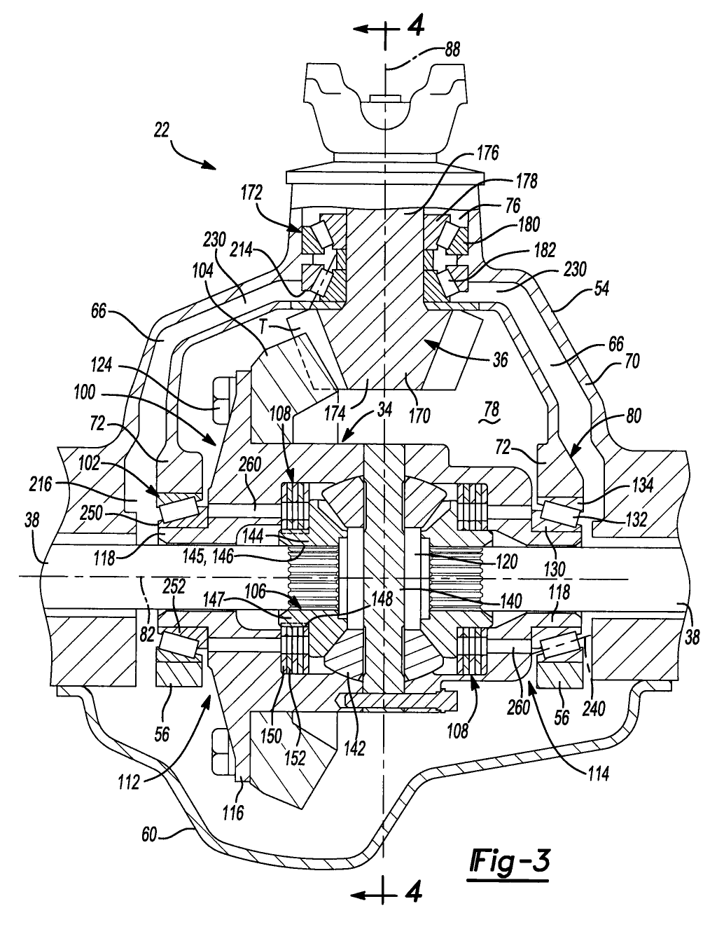

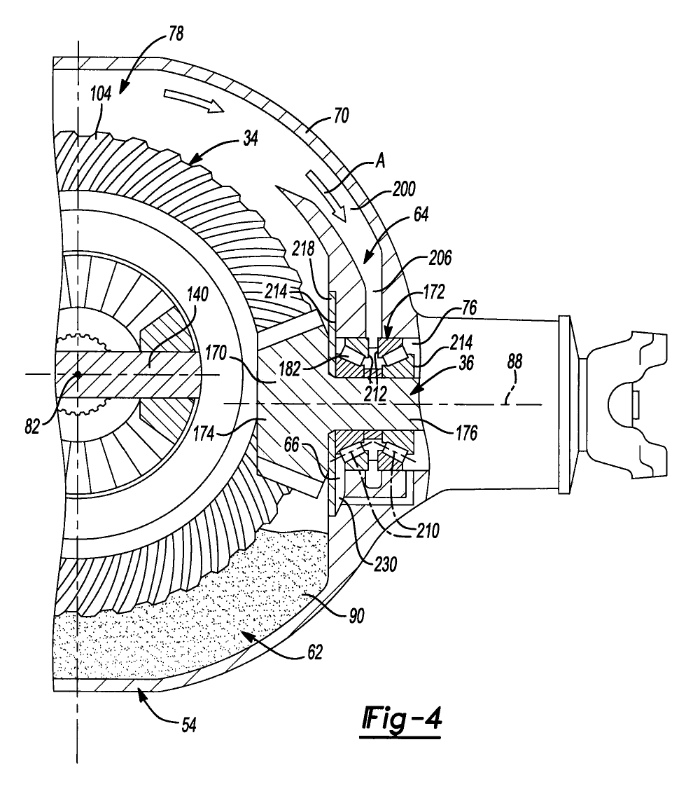

With reference to FIGS. 2 and 3, the rear axle assembly 22 can include an axle housing assembly 30, a differential assembly 34, an input pinion assembly 36 and a pair of axle shafts 38. The axle housing assembly 30 is illustrated to be a Salisbury-type axle housing assembly, but it will be appreciated that the teachings of the present disclosure have application to other types of axle housing assemblies, including independent and banjo axle housing assemblies for front and rear axle assemblies. Moreover, those of ordinary skill in the art will appreciate that the axle housing assembly 30 could be configured for a front axle, a rear axle, or an inter-axle differential between a pair of axles (e.g., a front axle and a rear axle) as desired. The axle housing assembly 30 can include a carrier housing 54, a pair of bearing caps 56, a pair of axle tubes 58 and a cover 60. The axle housing assembly 30 can include a lubricant sump or reservoir 62 (FIG. 4), a first oil gallery 64 (FIG. 4) and a pair of second oil galleries 66.

With reference to FIGS. 3 and 4, the carrier housing 54 can include a wall member 70 that can define a pair of bearing journals 72, a pair of tube bores 74 (FIG. 2), a pinion bore 76 and a differential cavity 78. Each of the bearing caps 56 can be coupled (e.g., removably coupled) to an associated one of the bearing journals 72, e.g., via a pair of threaded fasteners (not shown). The bearing caps 56 and the bearing journals 72 can cooperate to define a pair of differential bearing journals 80 on which the differential assembly 34 may be supported for rotation about a first axis 82. The tube bore 74 (FIG. 2) can be aligned to the differential bearing journals 80 and can be sized to receive the axle tubes 58 (FIG. 2) therein. The pinion bore 76 can intersect the differential cavity 78 and can extend along a second axis 88 that can be generally perpendicular to the first axis 82. The cover 60 can be removably coupled to the carrier housing 54 to close an open end of the differential cavity 78. The carrier housing 54 and the cover 60 can cooperate to define the lubricant reservoir 62, and a suitable lubricant 90 can be contained therein. The first and second oil galleries 64 and 66 can be integrally formed with or coupled to the carrier housing 54.

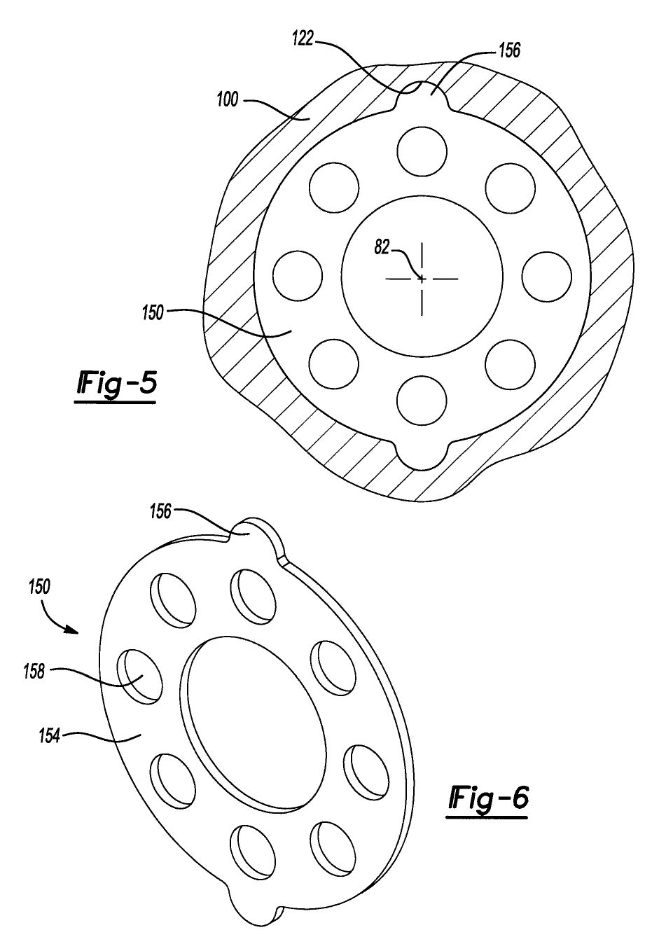

The differential assembly 34 can be a clutch-type limited slip differential and can include a differential case 100, a pair of differential bearings 102, a ring gear 104, a differential gear set 106 and a pair of clutch packs 108. In the particular example provided, the differential case 100 includes is unitarily formed, but those of ordinary skill in the art will appreciate that the differential case 100 may be unitarily formed or may be formed from two or more case components. The differential case 100 can comprise a first end 112, a second end 114, a mounting flange 116, a pair of trunnions 118 and a gear cavity 120 into which the differential gear set 106 can be received. The gear cavity 120 can be shaped to define a pair of locking elements 122 (FIG. 5). In the particular example provided, the locking elements 122 (FIG. 5) are grooves in the carrier housing 100, which extend parallel to the first axis 82 and that have a generally semi-circular cross-sectional shape. It will be appreciated, however, that the locking element(s) 122 could be shaped and/or formed differently. The ring gear 104 can be coupled to the mounting flange 116 via a plurality of threaded fasteners 124. The trunnions 118 can be hollow structures that can extend axially from the opposite ends of the differential case 100.

The differential bearings 102 can be any type of bearings, such as angular contact ball bearings (e.g., single row angular contact ball bearings, dual row angular contact ball bearings) or tapered roller bearings, and can include an inner bearing race 130, a plurality of rollers 132, and an outer bearing race 134. The inner bearing race 130 of each differential bearing 102 can be coupled (e.g., press-fit) to a corresponding one of the trunnions 118. The outer bearing race 134 of each differential bearing 102 can be received in a corresponding one of the differential bearing journals 80 (i.e., between a bearing cap 56 and an associated one of the bearing journals 72). In the example provided, the bearing cap 56 can apply a clamping force to the outer bearing race 134 that clamps the outer bearing race 134 to the differential bearing journal 80.

The differential gear set 106 can include a pinion shaft 140, which can extend through the differential case 100 generally perpendicular to the first axis 82, a pair of pinion gears 142, which can be rotatably mounted on the pinion shaft 140, and a pair of side gears 144 that can be in meshing engagement with the pinion gears 142. A bore 145 can be formed through each of the side gears 144. The bore 145 can be configured with a plurality of spline teeth 146. Each of the side gears 144 can include a hub portion 147 that can include a locking element, such as a plurality of spline teeth 148.

Each of the clutch packs 108 can be received in the gear cavity 120 between an associated one of the first and second ends 112, 114 and an associated one of the side gears 144. Each clutch pack 108 can include a set of first friction or clutch plates 150 and a set of second friction or clutch plates 152 that can be interleaved with the first clutch plates 150. The clutch packs 108 can be configured to engage the side gears 144 to the differential case 100 via frictional engagement between the first and second clutch plates 150 and 152, which can be affected by the amount of torque transmitted through a respective one of the side gears 144. More specifically, the side gears 144 can translate axially along the first axis 82 in an amount that depends on the magnitude of the torque that is transmitted from the pinion gears 142 to the side gears 144, to compress or release the clutch packs 108.

With reference to FIGS. 3 and 6, the first clutch plates 150 can include an annular body 154, a set of first locking elements 156 and a plurality of first lubrication apertures 158. The set of first locking elements 156 can provide the first clutch plates 150 with a non-circular shape that can be engaged to the locking elements 122 of the differential case 100 to permit relative axial movement of the first clutch plates 150 along the first axis 82 but inhibit rotation of the first clutch plates 150 relative to the differential case 100. In the particular example provided, the first locking elements 156 comprise semicircular tabs that extend from opposite sides of the annular body 154 and engage corresponding grooves formed in the differential case 100 as shown in FIG. 5, but it will be appreciated that other shapes/features could be employed in the alternative. The first lubrication apertures 158 can be formed through the annular body 154 and spaced radially outwardly from the first axis 82 by a predetermined radius. In the particular example provided, a quantity of eight first lubrication apertures 158 are employed and are spaced evenly apart about the circumference of the annular body 154.

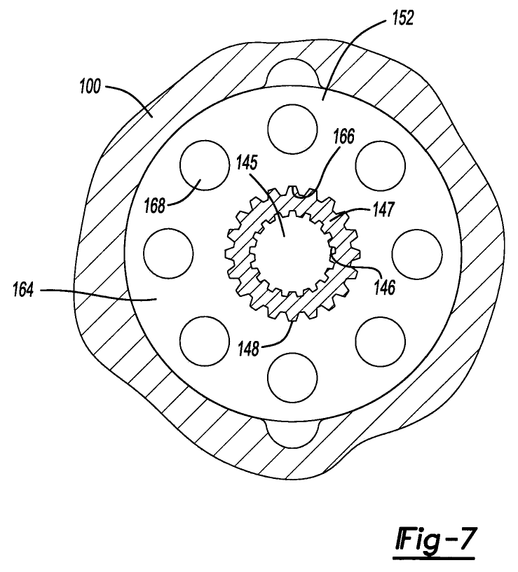

With reference to FIGS. 3 and 7, the second clutch plates 152 can include an annular body 164, a set of second locking elements 166 and a plurality of second lubrication apertures 168. The set of second locking elements 166 can provide the second clutch plates 152 with a non-circular shape that can be engaged to the hub portion 147 of an associated one of the side gears 144 to permit relative axial movement of the second clutch plates 152 along the first axis 82 but inhibit rotation of the second clutch plates 152 relative to the associated side gear 144. In the particular example provided, the second locking elements 166 comprise a plurality of circumferentially spaced spline teeth that extend about the inner perimeter of the annular body 164 and engage the locking elements on the hub portion 147 of the associated side gear 144 (i.e., the corresponding spline teeth formed on the hub portion 147 in the example provided), but it will be appreciated that other features/shapes could be employed. The second lubrication apertures 168 can be formed through the annular body 164 and spaced radially outwardly from the first axis 82 by the predetermined radius. In the particular example provided a quantity of eight second lubrication apertures 168 are employed and are spaced evenly apart about the circumference of the annular body 164.

Returning to FIGS. 3 and 4, the input pinion assembly 36 can be received in the pinion bore 76 in the carrier housing 54 and can include an input pinion 170 and a pair of pinion bearings 172. The input pinion 170 can include a pinion portion 174, which can be meshingly engaged to the ring gear 104, and a shaft portion 176. The pinion bearings 172 can be tapered roller bearings or angular contact ball bearings having an inner bearing race 178, an outer bearing race 180 and a plurality of rollers 182 disposed between the inner and outer bearing races 178 and 180. The pinion bearings 172 can be mounted on the shaft portion 176 and coupled to the carrier housing 54 to support the input pinion 170 for rotation about the second axis 88.

The axle shafts 38 can be received through the axle tubes 58 (FIG. 2) and can be coupled for rotation with the side gears 144 (e.g., via mating sets of spline teeth 146 and 170 formed on the inside diameter of the side gears 144 and the outer diameter of a portion of the axle shafts 38, respectively.

During operation of the vehicle 10 (FIG. 1) in a predetermined (e.g., forward) direction, rotary power is transmitted from the input pinion assembly 36 to the differential assembly 34 to cause the differential case 100 to rotate. More specifically, the teeth T of the input pinion 170 transmit rotary power to the ring gear 104, causing the ring gear 104 (and the differential case 100) to rotate about the first axis 82. As the ring gear 104 rotates, a radially outward portion of it passes through the lubricant 90 in the lubricant reservoir 62 and clings to the ring gear 104. Due to centrifugal force, a portion of the lubricant that has clung to the ring gear 104 will be slung from the ring gear 104.

With specific reference to FIG. 4, the first oil gallery 64 can include a first, open end 200 that can be shaped and positioned so as to collect lubricant 90 that has been slung from the ring gear 104. For example, the first open end 200 can have a frusto-conical shape that facilitates collection of slung lubricant 90. The collected lubricant may be slung directly into the open end 200 of the first oil gallery 64 as depicted by the arrows A, and/or could initially collect on the wall member 70 of the carrier housing 54 and drain into the open end 200. A second, opposite end 206 of the first oil gallery 64 can terminate adjacent the pinion bearings 172. Each of the pinion bearings 172, which can be a tapered roller bearing, can include a plurality of rollers 182 whose axes 210 can diverge outwardly from the second axis 88 with increasing distance from the other one of the pinion bearings 172. The lubricant 90 directed to a first side 212 of the pinion bearings 172 can be received between the rollers 182 and due to centrifugal force, can be directed out of a second, opposite side 214 of the pinion bearings 172. It will be appreciated that structures, such as seals or baffles, can be employed inhibit or limit the flow of lubricant 90 exiting the second side 214 of the pinion bearings 172 in a desired manner and/or to encourage a flow of lubricant from the differential bearings 102 into the differential case feed holes 260. In the particular example provided, a generally flat plate structure 218 is fitted about the pinion shaft 140 and received in the carrier housing 54 to urge the lubricant 90 that exits the second side 214 of the pinion bearings 172 to be received into a first end 230 of the second oil galleries 66.

With specific reference to FIG. 3, each of the second oil galleries 66 can extend from the first end 230, which is proximate the second side 214 of the pinion bearings 172, to a second end 216 that can be proximate an associated one of the differential bearings 102. The rollers 132 of the differential bearings 102 can be arranged such that their axes 240 diverge from the first axis 82 with decreasing distance toward an opposite one of the differential bearings 102. Accordingly, lubricant 90 discharged from the second oil galleries 66 proximate a first side 250 of the differential bearings 102 can be received between the rollers 132 and discharged from a second side 252 of the differential bearings 102. It will be appreciated that some portion of the lubricant 90 discharged from the second side 252 of the differential bearings 102 can be received through one or more apertures 260 in the differential case 100 that can permit lubricant 90 to be received into the gear cavity 120 to facilitate lubrication of the differential gear set 106 and the clutch packs 108.

The first lubrication apertures 158 in the first clutch plates 150 can be aligned to the apertures 260 in the differential case 100. It will be appreciated that as the second clutch plates 152 are coupled for rotation with the side gears 144, the second lubrication apertures 168 can be rotated into alignment with the first lubrication apertures 158 to permit fluid communication through the clutch pack 108 and further into the gear cavity 120 to facilitate lubrication of the differential gear set 106. It will also be appreciated that the apertures 260 in the differential case 100 and the first and second lubrication apertures 158 and 168 can be disposed in-line with a space between the inner race 132 and the outer race 134 of the differential bearings 102. Configuration of the lubrication path for lubricating the clutch pack 108 is less complex so that better lubrication can be achieved.

It will be appreciated that third oil galleries (not specifically shown) could be coupled in fluid communication to the first oil gallery 64 and/or second oil gallery 66 to distribute a portion of the lubricant 90 received into the first oil gallery 64 into openings (not specifically shown) in the carrier housing 54 so that such lubricant 90 can be received into the axle tubes 58. The lubricant 90 that is received into the axle tubes 58 can be employed to lubricate wheel bearings and seals, as well as to reject heat to the axle tubes to thereby aid in the cooling of the lubricant 90.

While the second oil galleries 66 have been illustrated as being fed lubricant from the one of the pinion bearings 172 that is closest to the teeth T of the input pinion 170 (i.e., the head bearing), it will be appreciated that the second oil galleries 66 could be fed lubricant from the other one of the pinion bearings 172 (i.e., the tail bearing, which is axially further from the teeth T of the input pinion 170) as shown in FIG. 3A. It will also be appreciated that a first one of the second oil galleries 66 could be fed from a first one of the pinion bearings 172 and the other one of the second oil galleries 66 could be fed from a second, different one of the pinion bearings 172 as shown in FIG. 3.

Moreover, while the axle assembly 22 (FIG. 1) has been illustrated and described as employing various oil galleries, it will be appreciated that the differential bearings 102 can be supplied with lubricating oil through conventional splash lubrication techniques and/or through a conventional fluid pump, which may be electrically driven or mechanically driven (e.g., through rotary power input to or transmitted through the axle assembly 22 (FIG. 1)).

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

What is claimed is:

1. A differential comprising:
a differential case having a first end, a second end opposite the first end and an internal cavity between the first and second ends, a plurality of first lubrication apertures being formed through the first end and extending into the internal cavity;
a differential gear set mounted to the differential case in the internal cavity, the differential gear set including a first side gear disposed proximate the first end of the differential case; and
a first clutch pack disposed between the first end and the first side gear, the clutch pack including a plurality of first clutch plates and a plurality of second clutch plates, the first clutch plates being non-rotatably coupled to the differential case, the second clutch plates being non-rotatably coupled to the first side gear, each of the plurality of first and second clutch plates including a plurality of second lubrication apertures extending axially therethrough.

2. The differential of claim 1, wherein axial movement of the first side gear along its rotational axis affects frictional engagement of the first and second clutch plates.

3. The differential of claim 1, wherein the first clutch plates comprise a tab that is received into a groove formed in the differential case and wherein engagement of the tab and the groove inhibits relative rotation between the first clutch plate and the differential case.

4. The differential of claim 1, wherein the differential further comprises a differential bearing having an inner race, an outer race and a plurality of bearing elements disposed between the inner and outer races, the inner race being mounted to a trunnion formed on the first end of differential case, the first lubrication apertures formed through the first end of the differential case being located radially relative to a rotational axis of the differential established by the differential bearing axially in-line with a space between the inner and outer races.

5. The differential of claim 4, wherein the bearing elements are rollers.

6. An axle assembly comprising:
a carrier housing defining a cavity;
a differential case received in the cavity;
differential bearings disposed between the carrier housing and the differential case, the differential bearings supporting the differential case for rotation about a first axis;
a differential gear set received in the differential case, the differential gear set including a pair of side gears;
a pair of clutch packs, each of the clutch packs being received between the differential case and an associated one of the side gears, each clutch pack having a plurality of lubrication apertures extending axially therethrough substantially parallel to the first axis;
a ring gear coupled to the differential case; and
a pinion engaging the ring gear and supported for rotation about a second axis that is substantially perpendicular to the first axis;
wherein lubrication apertures extend axially through opposite ends of the differential case between to create a fluid path by which lubricant discharged from the differential bearings can travel axially through the differential case and into an associated one of the clutch packs.

7. The axle assembly of claim 6, wherein the clutch packs comprise a plurality of first clutch plates and a plurality of second clutch plates that are interleaved with the first clutch plates.

8. The axle assembly of claim 7, wherein axial movement of the side gears along the first axis affects frictional engagement of the first and second clutch plates.

9. The axle assembly of claim 8, wherein the first clutch plates comprise a tab that is received into a groove formed in the differential case and wherein engagement of the tab and the groove inhibits relative rotation between the first clutch plate and the differential case.

10. The axle assembly of claim 9, wherein the differential bearings comprise an inner race and an outer race and wherein the lubrication apertures formed through the differential case are located radially relative to the first axis axially in-line with a space between the inner and outer races.

11. The axle assembly of claim 10, wherein the carrier housing comprises a lubricant passage extending to at least one of the differential bearings, the lubricant passage being configured to direct lubricant to the at least one of the differential bearings.

12. The axle assembly of claim 11, further comprising a pinion bearing supporting the pinion on the carrier housing and wherein the lubricant passage is coupled in fluid communication to the pinion bearing such that lubricant discharged from the pinion bearing at least partially feeds lubricant to the lubricant passage.

13. A method for operating an axle assembly having an axle housing, a differential and a pair of differential bearings supporting the differential on the axle housing for rotation about an axis, the differential having a differential case, a pair of friction clutches and a differential gear set with a pair of side gears, the method comprising:
rotating the differential about the first axis;
directing a lubricant onto the differential bearings, the lubricant being passed through the differential bearing toward the differential due to centrifugal force; and
passing the lubricant passed through the differential bearing axially through the differential case and axially through at least a portion of the friction clutches.

14. The method of claim 13, wherein the friction clutches comprise first friction plates that are non-rotatably coupled to the differential case and a plurality of second friction plates that are non-rotatably coupled to the side gears, the second friction plates being interleaved with the first friction plates.
